(19) United States
(12) Patent Application Publication
(10) Pub. No.: US 2014/0361730 A1
(43) Pub. Date: Dec. 11, 2014

(54) BI-DIRECTIONAL SWITCHING REGULATOR AND CONTROL CIRCUIT THEREOF

(71) Applicant: Nien-Hui Kung, HsinChu (TW)

(72) Inventor: Nien-Hui Kung, HsinChu (TW)

(73) Assignee: RICHTEK TECHNOLOGY CORPORATION, Chupei City (TW)

(21) Appl. No.: 13/911,976

(22) Filed: Jun. 6, 2013

(51) Int. Cl. H02J 7/00

(52) U.S. Cl. CPC H02J 7/0068
USPC 320/107

(57) ABSTRACT

The present invention discloses a bi-directional switching regulator and a control circuit of the bi-directional switching regulator. The bi-directional switching regulator includes a single power stage, an operation circuit, a power path management circuit and a power path controller. The power path management circuit includes a first power path switch and a second power path switch to be coupled to at least two batteries respectively, so that at least two batteries can be charged by the output voltage supplied by the single power stage.

### BACKGROUND OF THE INVENTION

1. Field of Invention

The present invention relates to a bi-directional switching regulator and a control circuit of the bi-directional switching regulator; particularly, it relates to such bi-directional switching regulator and control circuit which employs one single power stage but is capable of charging at least two batteries.

2. Description of Related Art

Please refer to FIG. 1, which shows a schematic diagram of a conventional bi-directional switching regulator. For the conventional bi-directional switching regulator 10 to charge two batteries BATA and BATB having different battery capacities, the bi-directional switching regulator 10 is required to include two power stages, i.e., the first power stage 11A and the second power stage 11B, and connect the two power stages to a single supply terminal BUS. The first power stage 11A has a corresponding first output terminal OUTA and the second power stage 11B has a corresponding second output terminal OUTB. The first output terminal OUTA and the second output terminal OUTB are electrically connected to the first battery BATA and the second battery BATB, respectively. The bi-directional switching regulator 10 can operate under a power supply mode (a discharging mode) or a charging mode. Under the charging mode, the bi-directional switching regulator 10 performs a buck power conversion, wherein it converts a supply voltage VBUS supplied from the supply terminal BUS to a first output voltage VOUTA at the first output terminal OUTA through the first power stage 11A and to a second output voltage VOUTB at the second output terminal OUTB through the second power stage 11B. That is, the higher supply voltage VBUS is converted to the lower first output voltage VOUTA and second output voltage VOUTB. Hence, the bi-directional switching regulator 10 can charge the first battery BATA and the second battery BATB, respectively. When the supply terminal BUS is connected to a device to be charged instead of a power source, the bi-directional switching regulator 10 can supply power to the supply terminal BUS from the first output terminal OUTA electrically connected with the first battery BATA or the second output terminal OUTB electrically connected with the second battery BATB (either but not both). This is the so-called power supply mode. Under the power supply mode, the same circuit shown in FIG. 1 will become a boost switching regulator and perform a boost power conversion. The first battery BATA or the second battery BATB converts a lower first battery voltage VBATA or a lower second battery voltage VBATB to the higher supply voltage VBUS through the first power stage 11A or the second power stage 11B, so as to supply power to the supply terminal BUS.

The first power stage 11A includes an upper-gate switch S2A, a lower-gate switch S3A and an inductor LA, all of which are coupled to a switching node LXA. The second power stage 11B includes an upper-gate switch S2B, a lower-gate switch S3B and an inductor LB, all of which are coupled to a switching node LXB. To protect the power source connected to the supply terminal BUS, a power protection transistor S1A can be provided in the bi-directional switching regulator 10 between the supply terminal BUS and a power protection node MIDA, and a power protection transistor S1B can be provided in the bi-directional switching regulator 10 between the supply terminal BUS and a power protection node MIDB. The power protection transistor S1A, the upper-gate switch S2A and the lower-gate switch S3A are controlled by a control circuit (not shown), and the power protection transistor S1B, the upper-gate switch S2B and the lower-gate switch S3B are controlled by another control circuit (not shown). In this conventional configuration, it is required for each battery to connect to a corresponding power stage, leading to a requirement of a huge numbers of devices. As a consequence, the size of the bi-directional switching regulator 10 is huge, and the manufacturing cost is high.

In view of the above, to overcome the drawbacks in the prior art, the present invention proposes a bi-directional switching regulator and a control circuit of the bi-directional switching regulator capable of charging at least two batteries by one single power stage, wherein the two batteries may having different battery capacities.

### SUMMARY OF THE INVENTION

A first objective of the present invention is to provide a bi-directional switching regulator.

A second objective of the present invention is to provide a control circuit of a bi-directional switching regulator.

To achieve the above and other objectives, from one perspective, the present invention provides a bi-directional switching regulator for use under a charging mode to convert a supply voltage supplied by a supply terminal to an output voltage at an output terminal, and for use under a discharging mode to supply power from the output terminal to the supply terminal, the switching regulator comprising: a single power stage coupled between the supply terminal and the output terminal, for converting power between the supply terminal and the output terminal; an operation circuit for generating an operation signal which controls the power stage; a power path management circuit coupled to the output terminal, the power path management circuit including: a first power path switch having one end coupled to the output terminal and another end coupled to a first battery, wherein the first battery has a first battery voltage; and a second power path switch having one end coupled to the output terminal and another end coupled to a second battery, wherein the second battery has a second battery voltage; and a power path controller for controlling the power path management circuit.

In one embodiment, the bi-directional switching regulator is controlled by one or a combination of two or more of the following manners wherein: (1) the output voltage is determined by a sum of a safety offset plus a higher one of the first battery voltage and the second battery voltage; (2) the output voltage is determined by the higher one of the first battery voltage and the second battery voltage; (3) the power path controller controls one of the first power path switch and the second power path switch which corresponds to the higher one of the first battery voltage and the second battery voltage to be fully conductive, and the other one of the first power path switch and the second power path switch to operate under a linear mode; and/or (4) when a difference between the output voltage and the first battery voltage or between the output voltage and the second battery voltage is smaller than a predetermined voltage level, the corresponding first power path switch or the second power path switch is turned OFF.

From another perspective, the present invention provides a control circuit of a bi-directional switching regulator, for use under a charging mode to control a power stage to convert a supply voltage supplied by a supply terminal to an output voltage at an output terminal, and for use under a discharging mode to control the power stage to supply power from the output terminal to the supply terminal, the control circuit comprising: an operation circuit for generating an operation signal which controls the power stage; a power path management circuit coupled to the output terminal, the power path management circuit including: a first power path switch having one end coupled to the output terminal and another end coupled to a first battery, wherein the first battery has a first battery voltage; and a second power path switch having one end coupled to the output terminal and another end coupled to a second battery, wherein the second battery has a second battery voltage; wherein the first power path switch and the second power path switch together couple the first battery and the second battery to the same output terminal; and a power path controller for controlling the power path management circuit.

In one embodiment, the operation circuit includes: a first comparator for comparing the first battery voltage with the second battery voltage or a signal related to the first battery voltage with a signal related to the second battery voltage to generate a comparison result; a multiplexer for outputting a higher one of the first battery voltage and the second battery voltage or a higher one of the signal related to the first battery voltage and the signal related to the second battery voltage according to the comparison result; an adder for adding the output of the multiplexer with the safety offset or a signal related to the safety offset to generate a summation result; and an error amplifier or a second comparator for comparing the summation result with a reference voltage to generate an output comparison signal; wherein the operation circuit generates the operation signal according to the output comparison signal.

In one embodiment, the operation circuit includes: a first comparator for comparing the first battery voltage with the second battery voltage or a signal related to the first battery voltage with a signal related to the second battery voltage to generate a comparison result; a multiplexer for outputting a higher one of the first battery voltage and the second battery voltage or a higher one of the signal related to the first battery voltage and the signal related to the second battery voltage according to the comparison result; and an error amplifier or a second comparator for comparing the output of the multiplexer with a reference voltage to generate an output comparison signal; wherein the operation circuit generates the operation signal according to the output comparison signal.

In one embodiment, the operation circuit further includes: a circuit for determining whether a difference between the output voltage and the first battery voltage or between the output voltage and the second battery voltage is smaller than a predetermined voltage level.

In one embodiment, the bi-directional switching regulator further comprises: a power protection transistor having one end electrically connected to the supply terminal and another end electrically connected to the power stage, for protecting a power source electrically connected to the supply terminal, wherein the power protection transistor includes a parasitic diode whose anode-cathode direction is opposite to a current direction from the power stage toward the supply terminal.

In one embodiment, the first power path switch or the second power path switch includes a transistor and the transistor includes a parasitic diode whose anode-cathode direction is opposite to a current direction from the output terminal toward the first battery or the second battery.

In one embodiment, the first power path switch or the second power path switch includes a transistor and the transistor includes a parasitic diode whose polarity is adjustable.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of a conventional bi-directional switching regulator.

FIG. 2 shows a schematic diagram of a bi-directional switching regulator according to an embodiment of the present invention.

FIGS. 3A-3E show several embodiments of the first power path switch and the second power path switch.

FIGS. 4A-4C show several embodiments of how the present invention generates the operation signals and the switch signals.

FIGS. 5A-5B show several embodiments of the power stage under a discharging mode.

### DESCRIPTION OF THE PREFERRED EMBODIMENTS

The above and other technical details, features and effects of the present invention will be will be better understood with regard to the detailed description of the embodiments below, with reference to the drawings. In the description, the words relate to directions such as “upper”, “lower”, “left”, “right”, “forward”, “backward”, etc. are used to illustrate relative orientations in the drawings and should not be considered as limiting in any way. The drawings as referred to throughout the description of the present invention are for illustration only, to show the interrelations between the apparatus and the devices, but not drawn according to actual scale.

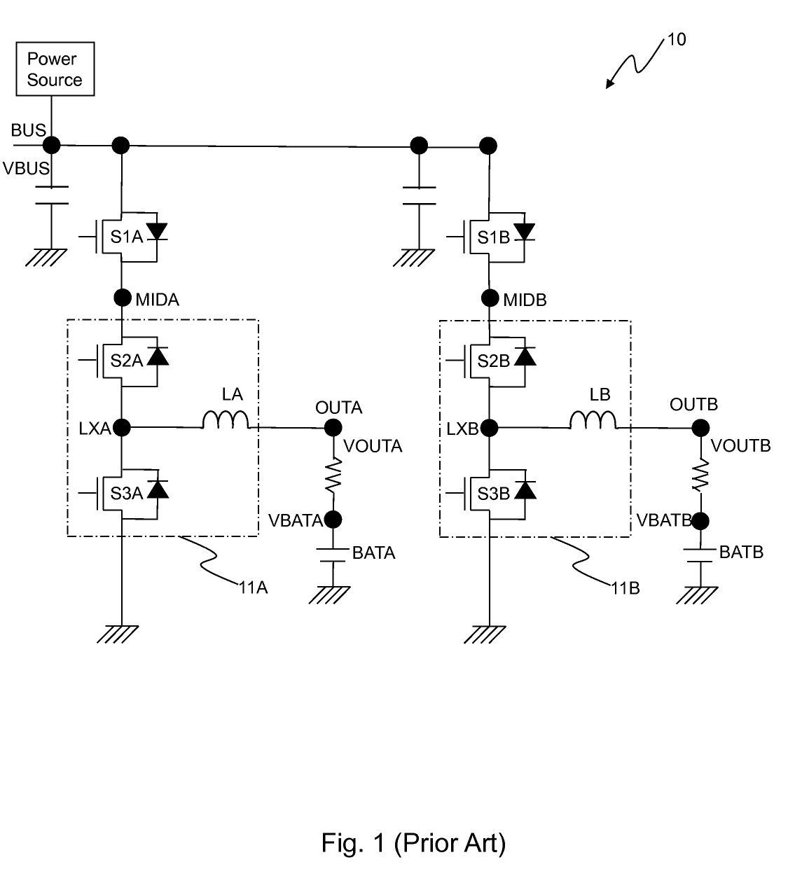

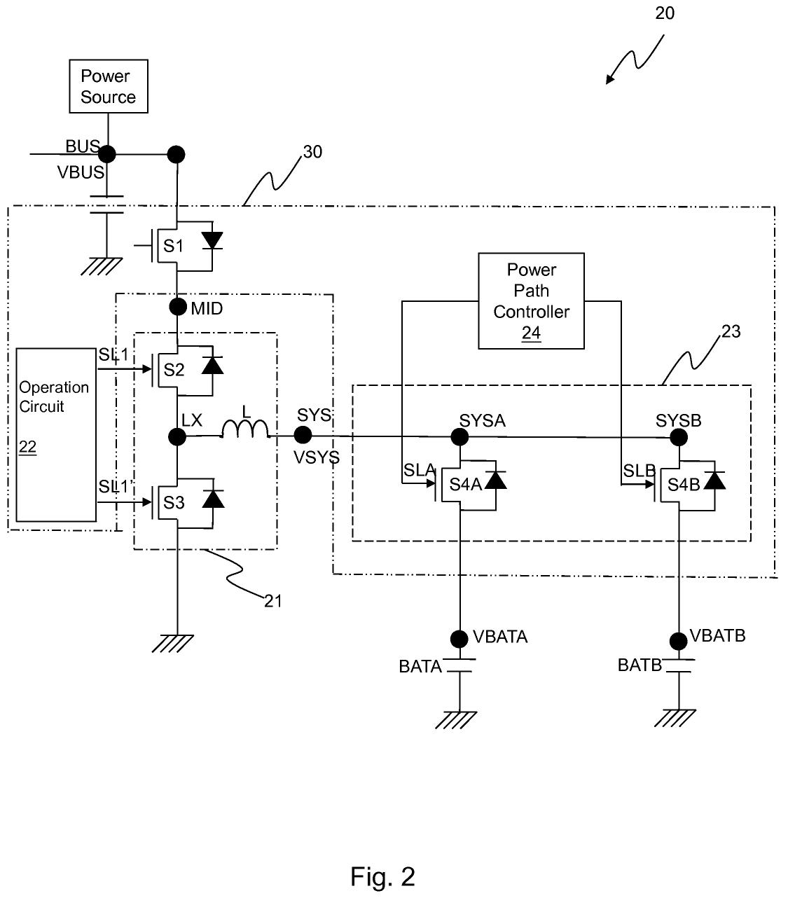

Please refer to FIG. 2, which shows a schematic diagram of a bi-directional switching regulator according to an embodiment of the present invention. The bi-directional switching regulator 20 can operate under a power supply mode (a discharging mode) or a charging mode. The bi-directional switching regulator 20 includes a single power stage 21, an operation circuit 22 and a power path management circuit 23. The power stage 21 includes: an upper-gate switch S2 having one end electrically connected to a power supply terminal BUS and another end electrically connected to a switching node LX; a lower-gate switch S3 having one end electrically connected to the switching node LX and another end electrically connected to ground; and an inductor L having one end electrically connected to the switching node LX and another end electrically connected to an output terminal SYS. The upper-gate switch S2 and the lower-gate switch S3 each can be, for example but not limited to, an NMOS transistor or a PMOS transistor. The operation circuit 22 generates operation signals SL1 and SL1′ to control the operation (ON/OFF state) of the upper-gate switch S2 and the lower-gate switch S3, so that power is transmitted from the supply terminal BUS to the output terminal SYS. In comparison with the conventional bi-directional switching regulator 10 (as shown in FIG. 1), the bi-directional switching regulator 20 of the present invention requires only one single power stage 21; the bi-directional switching regulator 20 is capable of electrically connecting one single output terminal SYS to at least two batteries by a power path management circuit 23. That is, the power path management circuit 23 has one end electrically connected to the output terminal SYS and other ends electrically connected to at least two batteries (namely, the first battery BATA and the second battery BATB). The first battery BATA and the second battery BATB each can be, for example but not limited to, a battery in an electronic device or a power bank. The bi-directional switching regulator 20 can charge the first battery BATA and the second battery BATB from the output terminal SYS. More specifically, the power path management circuit 23 includes a first power path switch S4A and a second power path switch S4B. The first power path switch S4A and the second power path switch S4B each can be, for example but not limited to, an NMOS transistor or a PMOS transistor. The first power path switch S4A is electrically connected between a first output node SYSA and the first battery BATA. The second power path switch S4B is electrically connected between a second output node SYSB and the second battery BATB. The first output node SYSA and the second output node SYSB are nodes having the same voltage level as the output terminal SYS. Thus, the first power path switch S4A and the second power path switch S4B are, in fact, commonly electrically connected to the output terminal SYS. In other words, as compared with the conventional bi-directional switching regulator 10 in which it is required to connect two different batteries having different battery capacities to two different output nodes (i.e., as shown in FIG. 1, the first battery BATA and the second battery BATB are respectively electrically connected to the first output terminal OUTA and the second output terminal OUTB), the bi-directional switching regulator 20 of the present invention is capable of electrically connecting one single output terminal SYS to the first battery BATA and the second battery BATB, through the power path management circuit 23. It should be noted that the number of the batteries is not limited to two, and can be more than two. The two batteries described in this embodiment are for illustrative purpose only, but not for limiting the scope of the present invention.

The first battery BATA and the second battery BATB described in this embodiment may have different battery capacities. The battery capacity can be represented by a state of charge (SOC) (%) or a voltage level (V). The details as to how the battery capacity is measured are well known to those skilled in the art, which are not redundantly repeated here. In this embodiment, the battery capacities for example are represented by voltages; the first battery BATA has a first battery voltage VBATA, which is for example 4.35V for illustrative purpose, and the second battery BATB has a second battery voltage VBATB, which is for example 4.2V for illustrative purpose.

When the bi-directional switching regulator 20 operates under the charging mode, it converts a supply voltage VBUS supplied from a supply terminal BUS to an output voltage VSYS at the output terminal SYS . In one embodiment, the present invention further includes a power path controller 24 which generates a first switch signal SLA and a second switch signal SLB to control the operations of the first power path switch S4A and the second power path switch S4B, respectively, so that the charging operations to the first battery BATA and the second battery BATB can be respectively controlled. The first power path switch S4A and the second power path switch S4B each can be a transistor having a parasitic diode whose anode-cathode direction is opposite to a current direction from the output terminal SYS toward the first battery BATA and the second battery BATB, so that the first power path switch S4A and the second power path switch S4B can control the charging operation to the first battery BATA and the second battery BATB, respectively.

When the supply terminal BUS requires power, the bi-directional switching regulator 20 can supply power to the supply terminal BUS from the output terminal SYS which is electrically connected to the first battery BATA and the second battery BATB. This is so-called power supply mode. Under the power supply mode, the same circuit shown in FIG. 2 will become a boost switching regulator and perform a boost power conversion. The first battery voltage VBATA of the first battery BATA or the second battery voltage VBATB are converted to the higher supply voltage VBUS through the power stage 21 so as to supply power to the supply terminal BUS.

Still referring to FIG. 2, in certain applications of the present invention, a power protection transistor S1 can be optionally (but not necessarily) provided between the supply terminal BUS and the upper-gate switch S2 (i.e., between the supply terminal BUS and the power protection node MID), and such power protection transistor S1 is capable of preventing a reverse current. In the embodiment shown in FIG. 2, the parasitic diode of the power protection transistor S1 has its anode electrically connected to the supply terminal BUS and its cathode electrically connected to the upper-gate switch S2. In other words, the polarity of the parasitic diode of the power protection transistor S1 is opposite to the polarity of the parasitic diode of the upper-gate switch S2. Accordingly, when the voltage at the node (MID or LX) connected to the upper-gate switch S2 is higher than the supply voltage VBUS, the parasitic diode of the power protection transistor S1 is capable of preventing a reverse current from flowing in the reverse direction from the upper-gate switch S2 to the supply terminal BUS. Thus, the power protection transistor S1 can protect the power source.

In one embodiment, the operation circuit 22, the power protection transistor S1, the power path management circuit 23 and the power path controller 24 can be all or partially integrated into a control circuit 30 as an integrated circuit by a semiconductor manufacturing process.

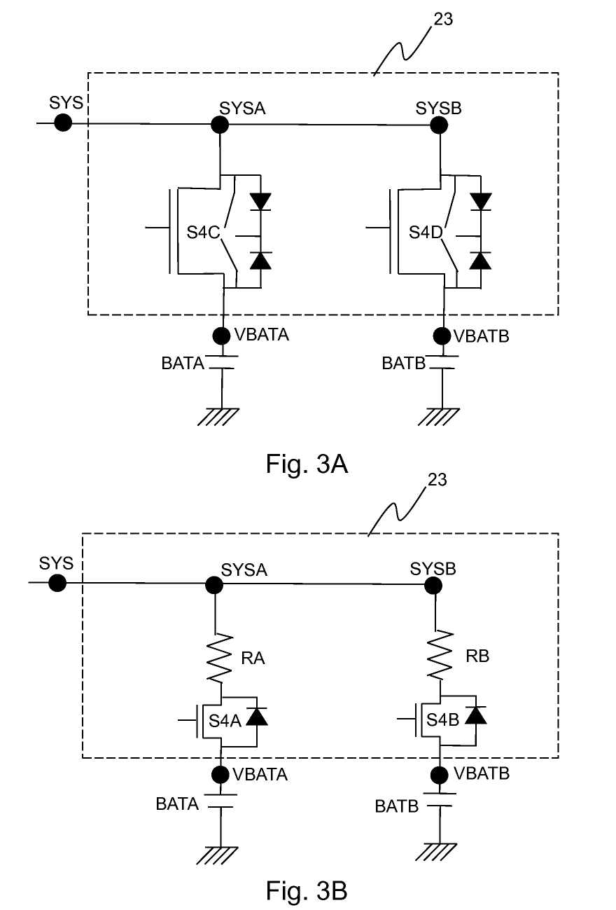

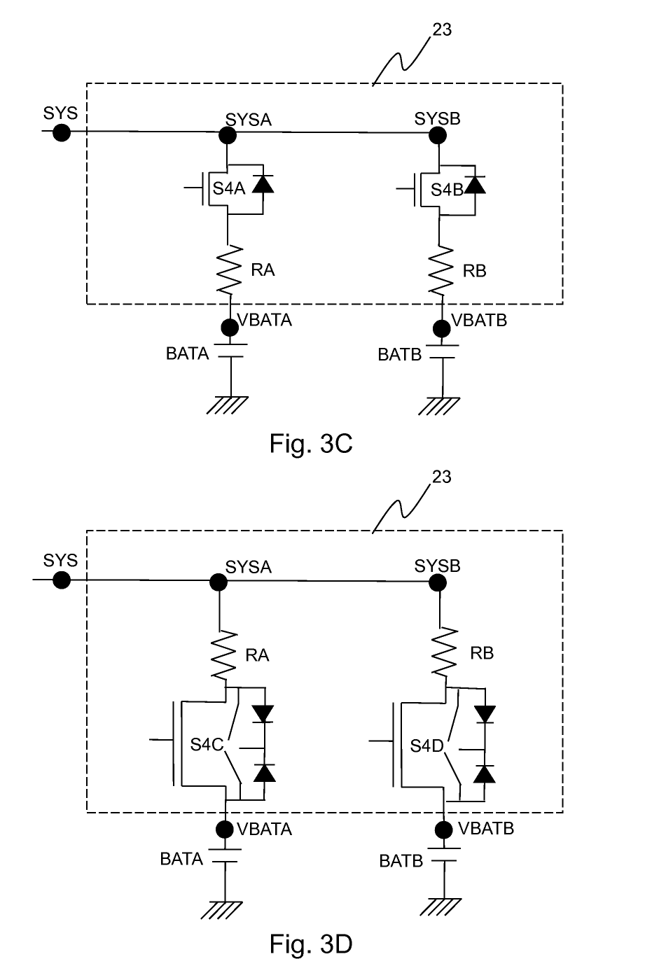

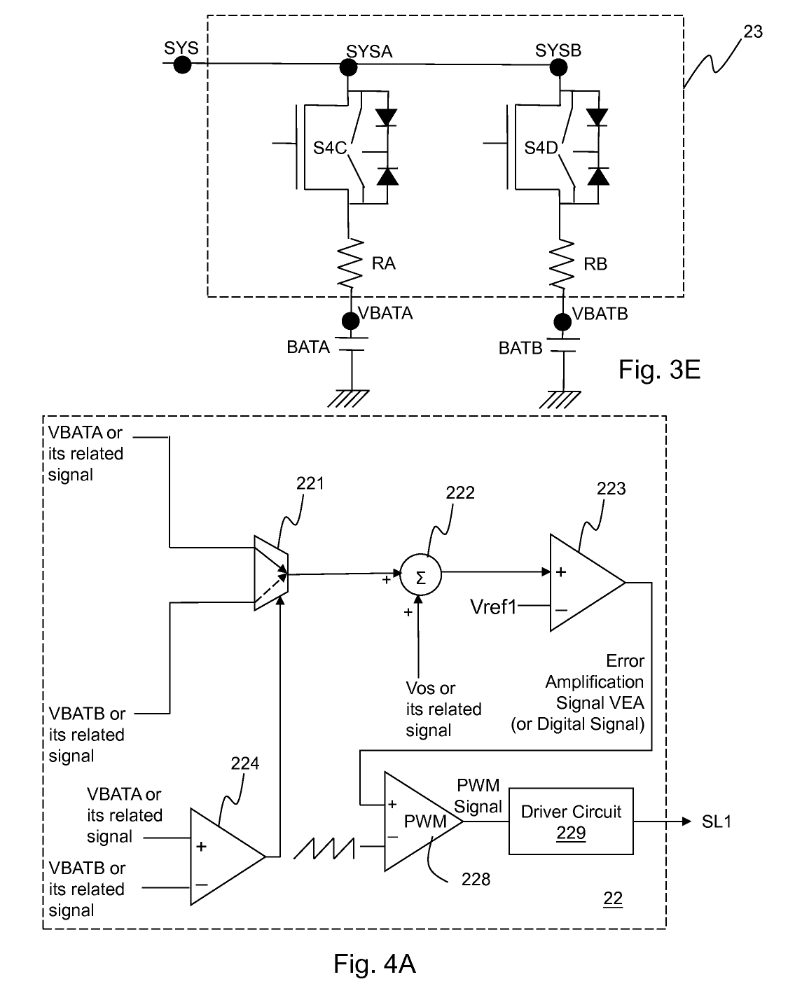

Please refer to FIGS. 3A-3E, which show several embodiments of the first power path switch and the second power path switch. In the embodiment shown in FIG. 3A, the first power path switch S4C and the second power path switch S4D each can be a transistor including a parasitic diode whose polarity is adjustable. When the output terminal SYS charges the first battery BATA or the second battery BATB, the anode-cathode direction of the parasitic diode can be set to be opposite to the charging direction. In the embodiment shown in FIG. 3B, the first power path switch S4A can be electrically connected to the output terminal SYS through a first resistor RA and the second power path switch S4B can be electrically connected to the output terminal SYS through a second resistor RB. In the embodiment shown in FIG. 3C, the first power path switch S4A can be electrically connected to the first battery BATA through a first resistor RA and the second power path switch S4B can be electrically connected to the second battery BATB through a second resistor RB. In the embodiment shown in FIG. 3D, the resistor is connected in the same way as that of FIG. 3B, but the first power path switch S4A and the second power path switch S4B are replaced by the first power path switch S4C and the second power path switch S4D each of which includes a parasitic diode whose polarity is adjustable. In the embodiment shown in FIG. 3E, the resistor is connected in the same way as that of FIG. 3C, but the first power path switch S4A and the second power path switch S4B are replaced by the first power path switch S4C and the second power path switch S4D each of which includes a parasitic diode whose polarity is adjustable. Note that in FIGS. 3B-3E, the the first resistor RA and the second resistor RB are provided for current detection, wherein the voltage differences across the first resistor RA and the second resistor RB respectively indicate the information of the charging current to the first battery BATA and the second battery BATB. However, the current detection is not limited to this approach, and it is also practicable and within the scope of the present invention to adopt any other current detection approach.

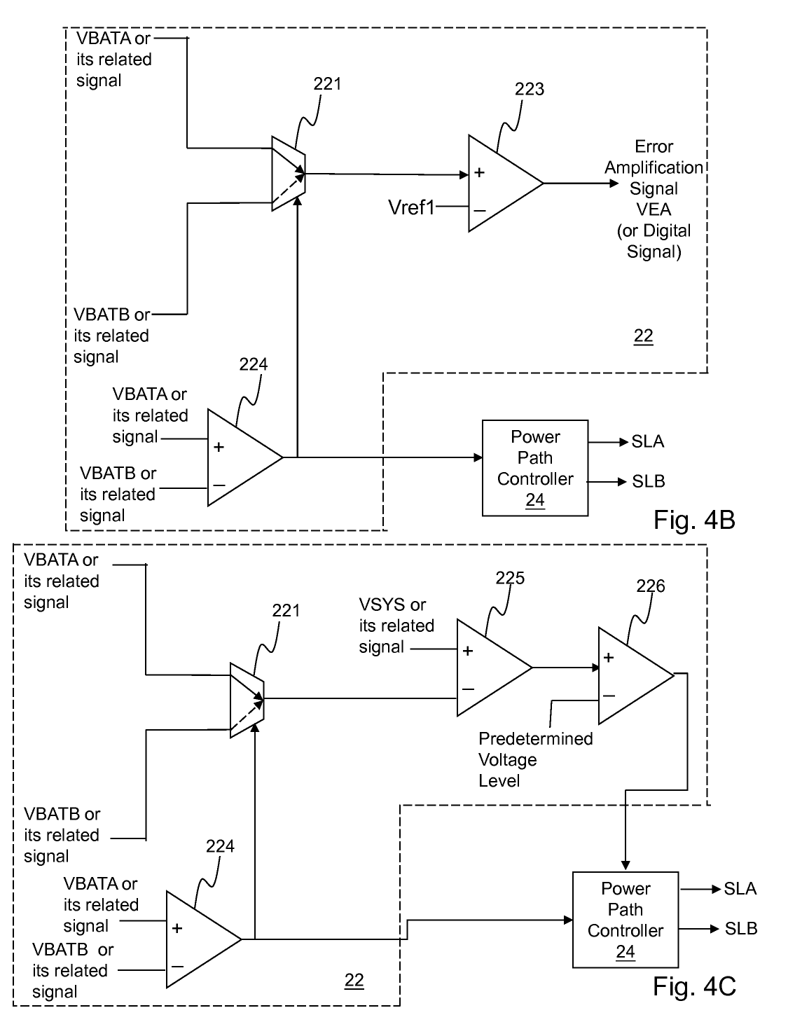

Please refer to FIGS. 4A-4C, which show several embodiments of how the present invention generates the operation signals and the switch signals. In the present invention, on one hand, the operation circuit 22 generates the operation signal SL1 (and SL1′, but only SL1 is shown for simplicity; the operation signal SL1′ can be a complementary signal of the signal SL1) to control the power conversion from the supply terminal BUS to the output terminal SYS, wherein the operation signals SL1 and SL1′ are generated according to the output voltage VSYS (or its related signal); on the other hand, the power path controller 24 generates the first switch signal SLA and the second switch signal SLB, which respectively control the first power path switch S4A and the second power path switch S4B to thereby control the charging operation to the first battery BATA and the second battery BATB. According to the relationship among the output voltage VSYS (or its related signal), the first battery voltage VBATA (or its related signal) and the second battery voltage VBATB (or its related signal) , the operation circuit 22 and the power path controller 24 respectively generate the operation signal SL1 and the first and the second switch signals SLA and SLB, by one or a combination of the approaches shown in FIGS. 4A-4C, as will be described below. Note that, in one embodiment, the operation circuit 22 and the power path controller 24 respectively generate the operation signal SL1 and the first and the second switch signals SLA and SLB solely according to the relationship among the output voltage VSYS (or its related signal), the first battery voltage VBATA (or its related signal) and the second battery voltage VBATB (or its related signal). In another embodiment, the operation circuit 22 and the power path controller 24 respectively generate the operation signal SL1 and the first and the second switch signals SLA and SLB not only according to the relationship among the output voltage VSYS (or its related signal), the first battery voltage VBATA (or its related signal) and the second battery voltage VBATB (or its related signal), but also according to information of the charging currents to the first battery BATA and the second battery BATB.

First, please refer to FIG. 4A. In this embodiment, the output voltage VSYS is determined by a higher one of the first battery voltage VBATA of the first battery BATA and the second battery voltage VBATB of the second battery BATB, plus a safety offset Vos. As shown in FIG. 4A, the operation circuit 22 of this embodiment includes a comparator 224, a multiplexer 221, an adder 222, an error amplifier 223, a pulse width modulation (PWM) signal generator 228 and a driver circuit 229. The comparator 224 compares the first battery voltage VBATA (or its related signal) with the second battery voltage VBATB (or its related signal) to generate a comparison result. The multiplexer 221 outputs a higher one of the first battery voltage VBATA (or its related signal) and the second battery voltage VBATB (or its related signal) according to the comparison result. That is, when the comparison result outputted by the comparator 224 shows that the first battery voltage VBATA (or its related signal) is greater than the second battery voltage VBATB (or its related signal), the output of the multiplexer 221 will be the first battery voltage VBATA (or its related signal). When the comparison result outputted by the comparator 224 shows that the first battery voltage VBATA (or its related signal) is smaller than the second battery voltage VBATB (or its related signal), the output of the multiplexer 221 will be the second battery voltage VBATB (or its related signal). The adder 222 receives the output of the multiplexer 221 and adds the output of the multiplexer 221 by the safety offset Vos (or its related signal) to generate a summation result. The error amplifier 223 compares the summation result with a reference voltage Vref1 to generate an output comparison signal, which is an error amplification signal VEA in this embodiment. (The error amplifier 223 can be replaced by a comparator. Under such situation, the output comparison signal will be a digital signal and will be discussed later). The PWM signal generator 228 compares the error amplification signal VEA with a ramp signal to generate a PWM signal. The driver circuit 229 generates the operation signal SL1 according to the PWM signal and controls the power conversion from the supply terminal BUS to the output terminal SYS. The relationship between the level of the first battery voltage VBATA and the level the second battery voltage VBATB affects the generation of the error amplification signal VEA, and thereby affects the generation of the operation signal SL1. Through the feedback control of the circuit, the output voltage VSYS is regulated at a level which is equal to the sum of the safety offset Vos plus a higher one of the first battery voltage VBATA and the second battery voltage VBATB, namely, VSYS=max(VBATA, VBATB)+Vos. In addition, under such circumstance, because there is at least such safety offset Vos between the output voltage VSYS and any one of the battery voltages, the first power path switch S4A and the second power path switch S4B can be controlled simply according to the charging requirement of the batteries, without concerning that the one of the batteries may charge the other.

Note that the above-mentioned structure for the operation circuit 22 to generate the operation signal SL1 is for illustrative purpose only, but not for limiting the scope of the present invention. The operation circuit 22 can generate an operation signal SL1 having a fixed frequency or a variable frequency by many other approaches. For example, the error amplifier 223 can be replaced by a comparator (and hence the error amplification signal VEA is replaced by a digital signal). A signal having a fixed pulse width (which can be used as the operation signal SL1) can be generated according to the rising edge and the falling edge of the output of the comparator. Furthermore, if the signal outputted by the PWM signal generator 228 is capable of driving the power stage 21, the driver circuit 229 can be omitted. In view of the foregoing, the spirit of the present invention should cover all such and other modifications and variations.

Please refer to FIG. 4B. In this embodiment, the output voltage VSYS can be determined by a higher one of the first battery voltage VBATA and the second battery voltage VBATB. As shown in FIG. 4B, the operation circuit 22 of this embodiment includes a comparator 224, a multiplexer 221 and an error amplifier 223 (in order to simplify FIG. 4B and to illustrate that the generation of the operation signal SL1 is not limited to the approach shown in FIG. 4A, the PWM signal generator 228 and the driver circuit 229 are omitted). The comparator 224 compares the first battery voltage VBATA (or its related signal) with the second battery voltage VBATB (or its related signal) to generate a comparison result. The multiplexer 221 outputs a higher one of the first battery voltage VBATA (or its related signal) and the second battery voltage VBATB (or its related signal) according to the comparison result. Specifically, when the comparison result outputted by the comparator 224 shows that the first battery voltage VBATA (or its related signal) is greater than the second battery voltage VBATB (or its related signal), the output of the multiplexer 221 will be the first battery voltage VBATA (or its related signal), and vice versa. Next, the error amplifier 223 compares the output of the multiplexer 221 with a reference voltage Vref1 to generate an error amplification signal VEA. The operation circuit 22 can adopt, for example but not limited to, the approach shown in FIG. 4A, to generate the operation signal SL1 according to the error amplification signal VEA to thereby control the power conversion from the supply terminal BUS to the output terminal SYS. Certainly, the operation circuit 22 can also adopt any other approach to generate the operation signal SL1. Through the feedback control of the circuit, the output voltage VSYS is regulated at a level which is equal to a higher one of the first battery voltage VBATA and the second battery voltage VBATB, namely, VSYS=max(VBATA, VBATB).

On the other hand, because there is no safety offset Vos between the output voltage VSYS and the higher one of the battery voltages, the charging current to the battery should be controlled. That is, the first power switch S4A and the second power switch S4B should be controlled (Certainly, under the circumstance where there is the safety offset Vos, the first power switch S4A and the second power switch S4B can also be controlled in this way). In this embodiment, the comparator 224 also outputs the comparison result to the power path controller 24. The power path controller 24 can then generate the first switch signal SLA and the second switch signal SLB to control the first power path switch S4A and the second power path switch S4B according to the comparison result. In a preferred embodiment, when the first battery voltage VBATA is greater than the second battery voltage VBATB, the first switch signal SLA controls the first power path switch S4A to be fully conductive and the second switch signal SLB controls the second power path switch S4B to operate under a linear mode (i.e., the switch operates in its linear region). When the second battery voltage VBATB is greater than the first battery voltage VBATA, the second power path switch S4B is fully conductive and the first power path switch S4A operates under a linear mode.

Please refer to FIG. 4C. This embodiment considers the charging requirement of the batteries in higher priority and control the first power path switch S4A and the second power path switch S4B accordingly, but when a difference between the output voltage VSYS and the first battery voltage VBATA or between the output voltage VSYS and the second battery voltage VBATB is smaller than a predetermined voltage level, the corresponding first power path switch S4A or the second power path switch S4B is turned OFF. As shown in FIG. 4C, the operation circuit 22 of this embodiment includes a first comparator 224, a multiplexer 221, an error amplifier 225 and a second comparator 226 (in order to simplify FIG. 4C and illustrate that the generation of the operation signal SL1 is not limited to the approach shown in FIG. 4A, the error amplifier 223, the PWM signal generator 228 and the driver circuit 229 are omitted). The first comparator 224 compares the first battery voltage VBATA (or its related signal) with the second battery voltage VBATB (or its related signal) to generate a comparison result. The multiplexer 221 outputs a higher one of the first battery voltage VBATA (or its related signal) and the second battery voltage VBATB (or its related signal) according to the comparison result. The error amplifier 225 compares the output of the multiplexer 221 with the output voltage VSYS (or its related signal) to generate an error amplification signal. The second comparator 226 compares the error amplification signal with a predetermined voltage level to generate a comparison result. This comparison result can show whether a difference between the output voltage VSYS and a higher one of the first battery voltage VBATA and the second battery voltage VBATB is smaller than a predetermined voltage level. If the difference is smaller than the predetermined voltage level, the power path controller 24 will turn OFF the corresponding first power path switch S4A or the corresponding second power path switch S4B while the other battery can keep being charged. The purpose for the above-mentioned design is to prevent the batteries from one charging to each other. However, if the batteries are allowed to charge each other, there is no need to adopt the above-mentioned design and the related circuits can be omitted.

It should be noted that the approach shown in FIG. 4C is only an illustrative example, but not for limiting the scope of the present invention; there are many equivalent ways to provide the same or similar functions. For example, the predetermined voltage level can be added to the output of the multiplexer 221 and the error amplifier 225 can be replaced by a comparator, and in this case the second comparator 226 can be omitted. The output of the error amplifier 225 (which is now replaced by a comparator) can then be inputted to the power path controller 24. Besides, the output voltage VSYS can also be directly compared with both the first battery voltage VBATA and the second battery voltage VBATB, instead of being compared with the higher one of the first battery voltage VBATA and the second battery voltage VBATB.

the above-mentioned control approaches shown in FIGS. 4A-4C can be implemented alone or in combination, and in implementation, all the devices shown in FIGS. 4A-4C can be included in the circuit, to provide flexibility that a user can determine any control approach that he desires.

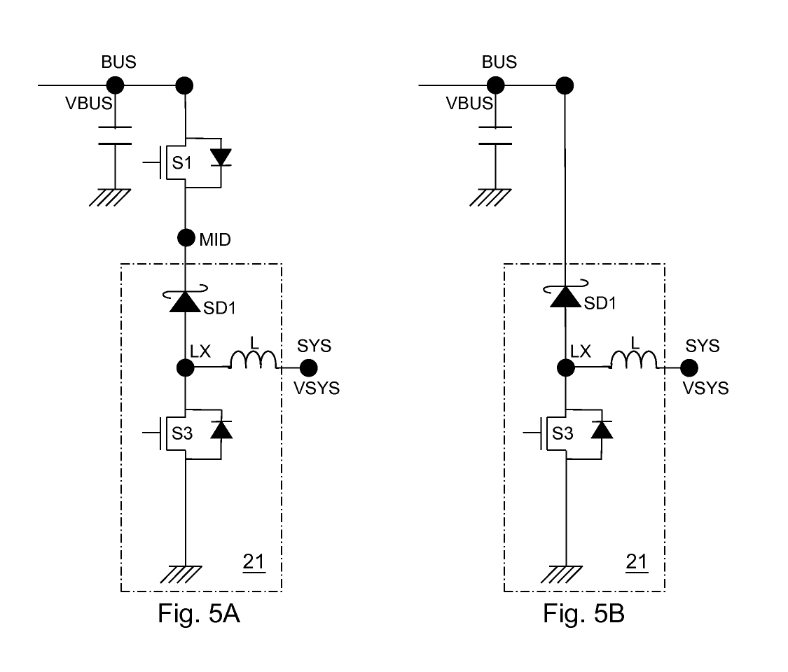

Please refer to FIGS. 5A-5B, which show several embodiments of the power stage under a power supply mode. When the bi-directional switching regulator 20 is under the power supply mode, the power stage 21 will become a boost switching power stage circuit. In one embodiment, the upper-gate switch S2 shown in FIG. 2 can be replaced by a Schottky diode SD1 while the power protection transistor S1 is reserved, as shown in FIG. 5A. Or, the Schottky diode SD1 replaces both the upper-gate switch S2 and the power protection transistor S1 shown in FIG. 2, as shown in FIG. 5B.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, a device which does not substantially influence the primary function of a signal can be inserted between any two devices in the shown embodiments, such as a switch. For another example, the power protection transistor S1, the upper-gate switch S2, the lower-gate switch S3, the first power path switch (S4A/S4C) and the second power path switch (S4B/S4D) each can be a PMOS transistor or an NMOS transistor, and the circuits generating signals for controlling these switches/transistors should be correspondingly designed. The power path controller 24 can be integrated into the operation circuit 22 instead of being a separate circuit. In view of the foregoing, the spirit of the present invention should cover all such and other modifications and variations, which should be interpreted to fall within the scope of the following claims and their equivalents.

What is claimed is:

1. A bi-directional switching regulator for use under a charging mode to convert a supply voltage supplied by a supply terminal to an output voltage at an output terminal, and for use under a discharging mode to supply power from the output terminal to the supply terminal, the switching regulator comprising:
a single power stage coupled between the supply terminal and the output terminal, for converting power between the supply terminal and the output terminal;
an operation circuit for generating an operation signal which controls the power stage;
a power path management circuit coupled to the output terminal, the power path management circuit including:
a first power path switch having one end coupled to the output terminal and another end coupled to a first battery, wherein the first battery has a first battery voltage; and
a second power path switch having one end coupled to the output terminal and another end coupled to a second battery, wherein the second battery has a second battery voltage; and
a power path controller for controlling the power path management circuit.

2. The bi-directional switching regulator of claim 1, wherein the bi-directional switching regulator is controlled by one or a combination of two or more of the following manners wherein:
(1) the output voltage is determined by a sum of a safety offset plus a higher one of the first battery voltage and the second battery voltage;
(2) the output voltage is determined by the higher one of the first battery voltage and the second battery voltage;
(3) the power path controller controls one of the first power path switch and the second power path switch which corresponds to the higher one of the first battery voltage and the second battery voltage to be fully conductive, and the other one of the first power path switch and the second power path switch to operate under a linear mode; and/or
(4) when a difference between the output voltage and the first battery voltage or between the output voltage and the second battery voltage is smaller than a predetermined voltage level, the corresponding first power path switch or the second power path switch is turned OFF.

3. The bi-directional switching regulator of claim 2, wherein the operation circuit includes:
a first comparator for comparing the first battery voltage with the second battery voltage or a signal related to the first battery voltage with a signal related to the second battery voltage to generate a comparison result;
a multiplexer for outputting a higher one of the first battery voltage and the second battery voltage or a higher one of the signal related to the first battery voltage and the signal related to the second battery voltage according to the comparison result;
an adder for adding the output of the multiplexer with the safety offset or a signal related to the safety offset to generate a summation result; and
an error amplifier or a second comparator for comparing the summation result with a reference voltage to generate an output comparison signal;
wherein the operation circuit generates the operation signal according to the output comparison signal.

4. The bi-directional switching regulator of claim 2, wherein the operation circuit includes:
a first comparator for comparing the first battery voltage with the second battery voltage or a signal related to the first battery voltage with a signal related to the second battery voltage to generate a comparison result;
a multiplexer for outputting a higher one of the first battery voltage and the second battery voltage or a higher one of the signal related to the first battery voltage and the signal related to the second battery voltage according to the comparison result; and
an error amplifier or a second comparator for comparing the output of the multiplexer with a reference voltage to generate an output comparison signal;
wherein the operation circuit generates the operation signal according to the output comparison signal.

5. The bi-directional switching regulator of claim 3, wherein the operation circuit further includes:
a circuit for determining whether a difference between the output voltage and the first battery voltage or between the output voltage and the second battery voltage is smaller than a predetermined voltage level.

6. The bi-directional switching regulator of claim 4, wherein the operation circuit further includes:
a circuit for determining whether a difference between the output voltage and the first battery voltage or between the output voltage and the second battery voltage is smaller than a predetermined voltage level.

7. The bi-directional switching regulator of claim 1, further comprising a power protection transistor having one end electrically connected to the supply terminal and another end electrically connected to the power stage, for protecting a power source electrically connected to the supply terminal, wherein the power protection transistor includes a parasitic diode whose anode-cathode direction is opposite to a current direction from the power stage toward the supply terminal.

8. A control circuit of a bi-directional switching regulator, for use under a charging mode to control a power stage to convert a supply voltage supplied by a supply terminal to an output voltage at an output terminal, and for use under a discharging mode to control the power stage to supply power from the output terminal to the supply terminal, the control circuit comprising:
an operation circuit for generating an operation signal which controls the power stage;
a power path management circuit coupled to the output terminal, the power path management circuit including:
a first power path switch having one end coupled to the output terminal and another end coupled to a first battery, wherein the first battery has a first battery voltage; and
a second power path switch having one end coupled to the output terminal and another end coupled to a second battery, wherein the second battery has a second battery voltage;
wherein the first power path switch and the second power path switch couple the first battery and the second battery to the same output terminal; and
a power path controller for controlling the power path management circuit.

9. The control circuit of claim. 8, wherein the control circuit controls the bi-directional switching regulator by one or a combination of two or more of the following manners wherein:
(1) the output voltage is determined by a sum of a safety offset plus a higher one of the first battery voltage and the second battery voltage;
(2) the output voltage is determined by the higher one of the first battery voltage and the second battery voltage;
(3) the power path controller controls one of the first power path switch and the second power path switch which corresponds to the higher one of the first battery voltage and the second battery voltage to be fully conductive, and the other one of the first power path switch and the second power path switch to operate under a linear mode; and/or
(4) when a difference between the output voltage and the first battery voltage or between the output voltage and the second battery voltage is smaller than a predetermined voltage level, the corresponding first power path switch or the second power path switch is turned OFF.

10. The control circuit of claim 9, wherein the operation circuit includes:
a first comparator for comparing the first battery voltage with the second battery voltage or a signal related to the first battery voltage with a signal related to the second battery voltage to generate a comparison result;
a multiplexer for outputting a higher one of the first battery voltage and the second battery voltage or a higher one of the signal related to the first battery voltage and the signal related to the second battery voltage according to the comparison result;
an adder for adding the output of the multiplexer with the safety offset or a signal related to the safety offset to generate a summation result; and
an error amplifier or a second comparator for comparing the summation result with a reference voltage to generate an output comparison signal;
wherein the operation circuit generates the operation signal according to the output comparison signal.

11. The control circuit of claim 9, wherein the operation circuit includes:
a first comparator for comparing the first battery voltage with the second battery voltage or a signal related to the first battery voltage with a signal related to the second battery voltage to generate a comparison result;
a multiplexer for outputting a higher one of the first battery voltage and the second battery voltage or a higher one of the signal related to the first battery voltage and the signal related to the second battery voltage according to the comparison result; and
an error amplifier or a second comparator for comparing the output of the multiplexer with a reference voltage to generate an output comparison signal;
wherein the operation circuit generates the operation signal according to the output comparison signal.

12. The control circuit of claim 10, wherein the operation circuit further includes:
a circuit for determining whether a difference between the output voltage and the first battery voltage or between the output voltage and the second battery voltage is smaller than a predetermined voltage level.

13. The control circuit of claim 11, wherein the operation circuit further includes:
a circuit for determining whether a difference between the output voltage and the first battery voltage or between the output voltage and the second battery voltage is smaller than a predetermined voltage level.

14. The control circuit of claim 8, wherein the first power path switch or the second power path switch includes a transistor and the transistor includes a parasitic diode whose anode-cathode direction is opposite to a current direction from the output terminal toward the first battery or the second battery.

15. The control circuit of claim 8, wherein the first power path switch or the second power path switch includes a transistor and the transistor includes a parasitic diode whose polarity is adjustable.
